(19) United States
(12) Patent Application Publication
(10) Pub. No.: US 2008/0298674 A1
(43) Pub. Date: Dec. 4, 2008

(54) Stereoscopic Panoramic imaging system

(75) Inventors: Robert G. Baker, Boynton Beach, FL (US); Frank A. Baker, Marianna, FL (US); James A. Connellan, Boca Raton, FL (US)

Correspondence Address: Robert Baker, 4762 Palo Verde Drive, Boynton Beach, FL, 33436-2912, US

(73) Assignee: Image Masters Inc., Boynton Beach, FL (US)

(21) Appl. No.: 12/154,734

(22) Filed: May 27, 2008

Related U.S. Application Data
(60) Provisional application No. 60/924,690, filed on May 29, 2007.

(51) Int. Cl. G06K 9/36

(52) U.S. Cl. 382/154

(57) ABSTRACT

An imaging system for producing stereoscopic panoramic images using multiple coplanar pairs of image capture devices with overlapping fields of view held in a rigid structural frame for long term calibration maintenance. Pixels are dynamically adjusted within the imaging system for position, color, brightness, aspect ratio, lens imperfections, imaging chip variations and any other imaging system shortcomings that are identified during calibration processes. Correction of pixel information is implemented in various combinations of hardware and software. Corrected image data is then available for storage or display or for separate data processing actions such as object distance or volume calculations.

### CROSS-REFERENCE TO RELATED APPLICATIONS

This non-provisional application for patent is related to U.S. provisional patent application 60/924,690 filed on May 29, 2007 and entitled “Stereoscopic panoramic imaging system.” The applicants for this non-provisional application remain the same as for the previously filed provisional application and include Robert G. Baker, Frank A. Baker, and James Connellan. The benefit under 35 USC section 119(e) of the United States provisional applications are hereby claimed, and the aforementioned application is hereby incorporated herein by reference.

### STATEMENT REGARDING FEDERALLY SPONSORED RESEARCH

Not Applicable

### REFERENCE TO SEQUENCE LISTING

Not Applicable

### BACKGROUND OF THE INVENTION

1. Field of the Invention

This invention relates to the field of immersive imaging, in which images of complete visual environments are captured collectively, describing a stereoscopic panoramic imaging system with high structural integrity and resistance to de-calibration.

2. Definitions as Used

Coplanar: Refers to imaging chips whose image collection surfaces reside on the same plane in space. The central angles of a pair of coplanar imaging subsystems are parallel.

Hyperstereo: A visual effect in which foreground objects in an image appear smaller than normally viewed in person due to a separation distance of image-collecting devices that is larger than the normal interocular separation distance of about 65 mm.

Hypostereo: A visual effect in which foreground objects in an image appear larger than normally viewed in person due to a separation distance of image-collecting devices that is smaller than the normal interocular separation distance of about 65 mm.

Imager: An electronic image capture device such as a Charge-coupled Device (CCD), Charge-injection Device (CID), or CMOS image sensor.

Imaging subsystem: An imager with its associated support circuitry and optical components, such as lens and lens holder.

Interocular: Refers to the difference between 2 eyes; associated in the present imaging system with separation distances between the 2 eyes of an average human being.

Monoscopic: Representations providing only a single visual perspective for each point in the field of view, as might be seen using just a single eye or captured using just a single imaging subsystem.

Panoramic: A wide field of view that encompasses 360° in the horizontal plane (the horizon in all directions) and a limited number of degrees in the vertical plane, such as 45° above and below the horizon.

Panospheric: A wide field of view that encompasses a complete 360° panorama in the horizontal plane and almost 90° above and below the horizon in the vertical plane, approaching the characteristics of a spherical view. With reference to this imaging system, the area under the system's support structure or tripod would be excluded from capture.

Pixel: Picture elements representing the individual rays of light that are captured by an imager or displayed on a display device.

Rectilinear: Lines that are parallel to axes at right angles. In this imaging system, it relates to stereo images that are generated from normal rectangular images that present no distortion effects.

3. Prior Art

Cameras, in general, record images or convert electromagnetic energy in various forms into other forms, such as electrical signals. Initially, this energy occurs in some portion of the electromagnetic spectrum that may include infrared, visible, ultraviolet or other wavelengths. While the principles of optics were first considered in the 4^{th} century B.C., cameras that produced lasting images of visible light energy were introduced in the early 19^{th} century.

Once techniques were created to capture images, enhancements were introduced to improve the viewing experience. The desire to produce and view stereoscopic images goes back to stereopticons and stereoscopes of the mid- to late-1800's, with the initial demonstration of a stereo camera in Germany circa 1844. Mass-produced consumer cameras of the early-to-mid-1900's were not practical for taking stereo photographs because re-positioning for the second view of a scene requires significant handling to yield satisfactory results. Hence, specialized cameras have been created for producing stereo images.

In recent years, the desire for immersive imaging experiences has led to many types of monoscopic cameras and their associated methods of acquiring panoramic images. Techniques employing Apple Corporation's QUICKTIME VR™ involve rotating a single camera with ordinary field of view through 360° to capture multiple images. Electronic versions of those images are then seamed together into a continuous panorama that is viewed on a computer display.

Wallace Clay in U.S. Pat. No. 3,225,651 presents an example of a regularly spaced planar array of camera elements. In this patent, individual cameras are set at varying separation distances and varying optical axes based upon relative distance to the photographic object. These optical axes preferably diverge to achieve panoramic capture of scenery. Cameras are uniformly distributed, not paired, so incidences of stereo acquisition are limited to overlap areas between adjacent imagers. This method provides complete stereo coverage of the scene only at a significant distance from the center of the array. Objects in the foreground of the imagers' views are generally only captured by individual cameras and are therefore not stereoscopically viewable. Clay's cameras therefore capture panoramic views that are stereoscopic only beyond the foreground, where the stereoscopic effect naturally diminishes with distance, making this device of marginal value for the combined purpose of panorama and stereoscopy.

U.S. Pat. No. 4,868,682 (Shimizu et al) describes another planar radial array of multiple imagers that captures a panoramic image set. Similar radial arrangements of multiple cameras can provide limited stereo image acquisition, but only in peripheral areas of lens coverage where adjacent images overlap. Examples of these are U.S. Pat. No. 5,657,073 (Henley) and U.S. Pat. No. 5,703,961 (Rogina et al). These inventions potentially provide stereoscopic visual coverage for an entire panorama depending on lens type and power chosen. However, imaging devices are intentionally not paired nor are they mounted exclusively at normal interocular separation distances. Thus, there is not a demonstrated design intention to avoid hyperstereo effects for any panoramic stereo images they may capture.

Peleg et al U.S. Pat. No. 6,665,003 discloses 2 methods of producing panoramic images. In a first embodiment, a radial array of imaging devices potentially captures stereoscopic images, but only at a significant distance from the center of the camera. This is due to the radial separation of imaging devices and the fact that they are not closely paired. This design further risks hyperstereo effects by not pairing imagers at normal interocular separation distances. In a second embodiment, Peleg captures images reflected from mirrors to paired imagers, using tangential views to create left-eye and right-eye mosaics. The problem with this design is both hyperstereo effects and visual interference by the mirrors in the viewing space of adjoining imagers. To avoid mirror interference, the mirrors must be angled out from a strictly tangential line. This then causes a need for additional processing to compensate for the off-angle views.

FIGS. 1A through 1E show the radial imager/camera arrays of prior art inventors Clay, Shimizu, Henley, Rogina and Peleg. In Clay's FIG. 1A, a camera 2 is attached to radial arm 4 with pivot point 6 and moved through various radial positions by movement of the arm. Field of view lines 8 show that repositioning the camera by arm movement will allow overlapping images. Clay demonstrates panoramic capture but not at a single instant in time. In Shimizu's design in FIG. 1B, cameras 20 are mounted fixedly around a central point 18 to capture a panoramic image, but there is no overlap demonstrated among fields-of-view 16 and no stereoscopic capability derived therefrom. In FIG. 1C, Henley mounts cameras 10 on a platform 12 to capture a panoramic image with overlapping fields-of-view 14 that could potentially be developed into usable stereoscopic imagery. When used as a pair for stereoscopic viewing, Henley's imager surfaces are not coplanar, however, nor are they necessarily at normal interocular separation distances. The impact is that significant processing is required to generate stereoscopy on even small portions of Henley's panorama.

Rogina has a configuration in FIG. 1D that is similar to Henley's with cameras 100 uniformly distributed around and resting on a platform 102 about a central point 104. This defines a radial imaging structure capable of capturing stereoscopic image content in overlapping fields-of-view. Rogina uses epipolar techniques to synthesize the two stereoscopic views rather than using two directly-captured images, limiting real-time performance in stereoscopy. Peleg demonstrates paired imagers 61 around a central point in FIG. 1E, but he adds mirrors 62 to change each view to a tangential angle. Rays 63 are traced to show how they reflect from the scene off the mirrors to the imagers. Peleg then merges all left views and all right views into respective mosaics, preventing the pairing of side-by-side views to make a stereoscopic scene. One obvious drawback is the interference of the physical mirrors in the fields-of-view of adjoining imagers. Further, the construction of the mosaics takes additional processing with the concomitant expenses of hardware and software, as well as time.

A non-planar (dodecahedral) arrangement of imagers as described in U.S. Pat. No. 5,703,604 (McCutchen) similarly captures stereoscopic images only in the overlap regions of adjacent images. However, stereo coverage is not necessarily complete nor are imagers appropriately spaced to simulate normal eye-separation distances. In FIG. 1F, Pierce et al in U.S. Pat. No. 6,947,059 similarly describe a spherically-shaped stereoscopic panoramic image capture device using a plurality of imagers 30. Imagers are not coplanar but are spaced at uniform and unspecified separation distances, so adjustments must be made to compensate for hyperstereo and hypostereo effects. Both Pierce's and McCutchen's cameras share the limitation that the various images when viewed as pairs are of necessity at a variety of angles and elevations. As such, they are therefore not practical for producing normal panoramas in stereoscopy.

All of the afore-mentioned imaging arts suffer from impractical production of stereo images across a wide panorama. Further complex processing is needed in all cases to adjust for rectilinearity and interocular spacing effects to construct usable stereo images around the horizontal viewing plane.

Most multi-imager cameras also suffer in keeping imagers aligned with respect to each other. A failure in calibration retention makes these prior arts impractical for use on a day-to-day basis. Barman et al in U.S. Pat. No. 6,392,688 solve inter-imager registration by using a solid mechanical plate to lock multiple imagers and lenses into fixed relative positions. This implementation helps maintain calibration of stereo imager pairs over longer periods of time than has otherwise been achieved with conventional mechanical arrangements. As a single plate, Barman's approach works well for viewing in a single direction but does not address instantaneous panoramic capture. His invention has two points of variability: the small screws into holes holding individual imager boards, and soldering of the imaging chip onto that board. These are mitigated through soldering or gluing down plus a calibration step.

Shown in FIG. 2, Barman screws individual imager chips 53 on imager boards 54 onto the plate 52, into which lens assemblies 51 are also screwed until a clear focus is obtained. It is recognized that variations in positioning of components is related to several factors. These factors include the accuracy of attachment of imagers to their circuit boards, diameter and tightness of holes in the imager circuit boards, and positions of drilled holes in the plate. All of these variables are minimized initially by a factory calibration step and kept small over time by soldering components into place and using adhesives on screws. The key factor is setting all the components in their respective positions and then calibrating their relative locations to each other. The disadvantage of Barman is that the planar nature of the metal plate limits stereo viewing to one direction and to the extent of angular coverage of the lenses.

Another single-camera method uses hemispheric or parabolic mirrors to reflect surrounding scenery onto film or an electronic imager as an annular ring, examples of which are U.S. Pat. No. 6,392,687 (Driscoll Jr. et al) and U.S. Pat. No. 5,854,713 (Kuroda et al). While providing a panoramic view, none of these inventions provides a stereoscopic view of the surroundings.

Jackson et al. in U.S. Pat. No. 6,301,447 define a camera mounting device for shifting the position of a fisheye-lens-equipped camera to two different viewpoints of a scene, achieving a stereo still image of a hemisphere with non-moving content at two points in time. The obvious limitation is that objects can shift or move and lighting conditions can change during the time it takes to reset the position of the camera. Another problem is that mechanical movements of a camera will result in different relative positions of images at a fine resolution. This will force the user to recalibrate each set of images to produce a usable stereo image set. Furthermore, video acquisition is not possible with this design.

The hyperstereo effect relates to the change in perceived relative sizes of objects in the captured visual space due to positioning of the paired imaging devices. Hyperstereo is specifically defined as separation distances for a pair of imaging devices that is greater than the normal interocular separation distance of humans of about 65 mm. The visual effect in reproducing these images is that objects in the foreground appear minimized in size relative to their backgrounds as they might be perceived normally. This miniaturization effect varies with distance from the imager pair and makes the images unsuitable for normal stereoscopic viewing of 3D space. Similarly, the hypostereo effect is an increase in the size of foreground objects relative to their normally viewed appearance. It is the result of spacing imaging devices closer than the normal interocular separation distance. If the desired outcome is a perspective-correct stereoscopic image with the least amount of ancillary processing, normal eye spacing must be observed in the acquisition mechanism.

Numerous patents employ a plurality of cameras arranged on an arc with convergent optical axes. Examples include U.S. Pat. No. 3,518,929 (Glenn Jr. et al), U.S. Pat. No. 3,682,064 (Matsunaga et al), U.S. Pat. No. 4,062,045 (Iwane), U.S. Pat. No. 4,747,378 (Hackett, Jr. et al), U.S. Pat. No. 4,931,817 (Morioka), and more recently, U.S. Pat. No. 6,154,251 (Taylor). Obviously, with a plurality of cameras, inward-looking systems may achieve stereo imaging, but convergent points-of-view do not provide for panoramic capture and are therefore not the subject of this inventive field.

There is yet a different group of camera types for stereo imaging made up of designs that employ motors to direct paired imagers to different points of view. These successfully provide wide visual coverage at video rates but only for the limited field of view captured through their lenses at a given instant in time. Such cameras are typified by U.S. Pat. No. 4,418,993 (Lipton), U.S. Pat. No. 6,301,446 (Inaba), and U.S. Pat. No. 4,879,596 (Miura et al). A further limitation to this type of design is difficulty in maintaining calibration between cameras and loss of precision due to wear and variation in mechanical movements.

To capture large fields-of-view, wide angle lenses are often used with imagers. Pixel positions must then be remapped to adjust for the distortion effect of the lenses. In terms of remapping pixels from images to adjust for lens distortions, Juday et al. in U.S. Pat. No. 5,067,019 and Zimmermann in U.S. Pat. No. 5,185,667 operate on a collective panospheric or hemispheric image set of pixels after they have been transferred from the camera. This remapping facilitates viewing of portions of the overall image and providing the equivalent of a mechanical pan, tilt, zoom or rotation of a physical camera. These image transformation processes are based on numerically calculated values using software applications usually operating on a separate computing platform after transferring the images from the cameras. As such, they do not address flaws existing in the actual imaging subsystems themselves. Imaging subsystem flaws exist in lenses and imagers and affect color, brightness, and pixel displacement. None of these cameras produces stereo images or handles imager-pair-related differences.

In summary, there are several ways for capturing panoramic and other wide field of view images, some of which have limited stereo capture or video capabilities but rarely both. Most are for specialized use and are delicate in design, requiring frequent recalibration to retain optimum stereo configurations. Image transform engines have been designed that remap pixels of a camera's output but do not correct all distortions, color aberrations, and lens errors in a single process. Nor are there any that transform images automatically prior to image transmission or storage.

Despite the varieties of stereoscopic or panoramic solutions available, there exists an unfulfilled need for a stereoscopic imaging system that can capture both still and video panoramic images at normal interocular separation distances with a variety of lens types. With known shortcomings of optical components, such a system must dynamically correct for identified optical deficiencies to provide either individual stereo views or an immersive visual experience upon display on appropriate stereo viewing devices.

In summary, there currently exists no imaging system that effectively captures stereoscopic panoramic or panospheric images and handles flaws and variations in the system on a dynamic and automated basis. The present imaging system further improves upon prior art stereoscopic camera designs by forming a rigid framework in which the imaging subsystems are held. This design improvement maintains calibration of optical components over long periods of time without the requirement for recalibration or adjustments.

### BRIEF SUMMARY OF THE INVENTION

It is therefore an object of the present invention to provide an improved imaging system for capturing stereoscopic panoramic images. Such a system will have numerous advantages.

One advantage is that by using multiple imager pairs to capture stereoscopic images instead of a single imaging pair, this system captures stereo images in all directions at one time with no moving parts. This permits immersive stereo imaging at video rates.

Another advantage is the construction using a rigid mechanical frame, which allows the system to maintain high levels of calibration from image set to image set and over extended periods of time.

Yet another advantage of this imaging system is that once the rigid framework has been calibrated, the stereoscopic design maintains consistent parallax. This means that image sets derived from it will present consistent views to users. The design also supports highly repeatable dimensional measurements of scenes, which are carried out through calculations in either hardware or software.

From a practical standpoint, the advantage of the embodiment that uses a framework of multiple replaceable imager pair boards is that it strikes a balance between resistance to de-calibration from shock or mechanical vibrations and ease of construction or repair. This flexibility provides a commercial advantage over alternative designs.

Still another advantage is the installation of imaging subsystems at standard interocular separation distances for humans. With this construction, stereoscopic image pairs naturally maintain normal object relationships between foreground and background objects and prevent hyperstereo and hypostereo magnification effects. They further eliminate or reduce complex post-acquisition computations.

Yet another advantage is the processing means for dynamic pixel adjustment, which automatically corrects for shortcomings in the optical components of the imaging system. It handles different lens types with their inherent distortions and flaws, as well as imager color variations and stuck pixels. Instead of using a generic corrective mechanism that may not address an individual unit, dynamic pixel adjustment handles specific characteristics of each imaging system on a pixel-by-pixel basis.

These advantages are manifest in a collection of embodiments of the present invention.

One embodiment is an imaging system with a plurality of image capture devices and lenses in a framework for rigidly positioning components in relation to each other. The image capture devices and lenses are used for translating electromagnetic radiation into electrical energy representing pixel data. The framework positions the image capture devices and lenses as pairs of imaging subsystems in which the arrays of the image capture devices are coplanar. These imager pairs are held firmly in place in relation to each other and each pair is directed outwardly from a central point in space so that all pairs collectively cover at least 360° of a field of view. The purpose of this positioning is to create a collection of stereoscopic views covering a full panoramic field of view. The purpose of the rigid framework is to maintain calibration among imaging elements, a necessary feature of practical stereoscopic cameras.

Another embodiment uses lenses that are similar and of a consistent type in a given implementation, so as to match the right and left eye views of a stereoscopic image. These lenses are selected from a group of common optical lenses assemblies consisting of wide angle, narrow angle, fisheye, zoom or other lens types that are ordinarily used to refract light onto image capture devices.

In yet another embodiment, the image capture devices and their associated lenses of each optical subsystem imager pair are spaced at normal human interocular separation distances of about 65 mm. Putting imaging system components where the eyes would see their respective views minimizes hyperstereo and hypostereo visual effects upon reproduction.

In another embodiment the image capture devices and their respective lenses are placed on imager pair board assemblies. These board assemblies are then configured and mounted in such a way that the collection of them forms a regular polygon when viewed from above. Each such board assembly has one or more vertical support members firmly affixed on the back, and these members are screwed into base and top plates to create a rigid framework that maintains the relative positions of optical system components for long periods of time, thereby reducing recalibration requirements.

Still another embodiment positions the image capture devices with their respective circuit boards on a single solid frame, onto which the lenses are also attached. This solid frame is further joined to base and top plates to create a rigid framework that maintains the relative positions of optical system components for long periods of time, thereby reducing recalibration requirements.

In another embodiment, the imaging system is comprised of a plurality of image capture devices and lenses in a framework for rigidly positioning components in relation to each other, as well as processing means for dynamic adjustment of pixel data. The processing means combines acquired pixel data with image calibration data that has been previously capture to change characteristics of the newly acquired pixel data. The benefit of this processing is the production of corrected stereoscopic image data sets that cover a full panoramic or panospheric field of view. As with other embodiments, the image capture devices and lenses are used for translating electromagnetic radiation into electrical energy representing pixel data. The framework positions the image capture devices and lenses as pairs of imaging subsystems in which the arrays of the image capture devices are coplanar. These imager pairs are held firmly in place in relation to each other and each pair is directed outwardly from a central point in space so that all pairs collectively cover at least 360° of a field of view. As before, the purpose of this positioning is to create a collection of stereoscopic views covering a full panoramic field of view. The purpose of the rigid framework is to maintain calibration among imaging elements, a necessary feature of practical stereoscopic cameras.

In another embodiment, an imaging system is comprised of a plurality of image capture devices and their respective lenses mounted in a rigid framework, and the system includes dynamic pixel adjustment processing means for correcting pixel characteristics such as position, color, and brightness. Hardware or software means are provided in which each pixel's characteristic values are temporarily stored for comparison with calibration values that have been previously determined. The comparisons take place so that the characteristic values can be corrected for preferred values, an example of which is positional placement of a pixel from a distorted or flawed lens. Other characteristics that are adjusted include color and brightness on a per-pixel basis for pixels that are not stuck on or off. The dynamic pixel adjustment method also handles determination of new values for color and brightness for pixels stuck either on or off by interpolating values from adjacent surrounding pixels. The method further adjusts characteristic values for comparable pixel positions between two optical subsystems of an imaging pair, balancing for more common brightness values. The purpose of these correction steps is to handle imaging system shortcomings such as lens distortion and flaws, differences from ideal values of color and brightness for pixels of image capture devices, and differences between relative brightness values of individual image capture devices.

Additional advantages of these embodiments of the present invention will become apparent from the following description.

### BRIEF DESCRIPTIONS OF THE SEVERAL VIEWS OF THE DRAWING

FIGS. 1A through 1E show the radial imager/camera arrays of prior art inventors Clay, Shimizu, Henley, Rogina and Peleg, respectively.

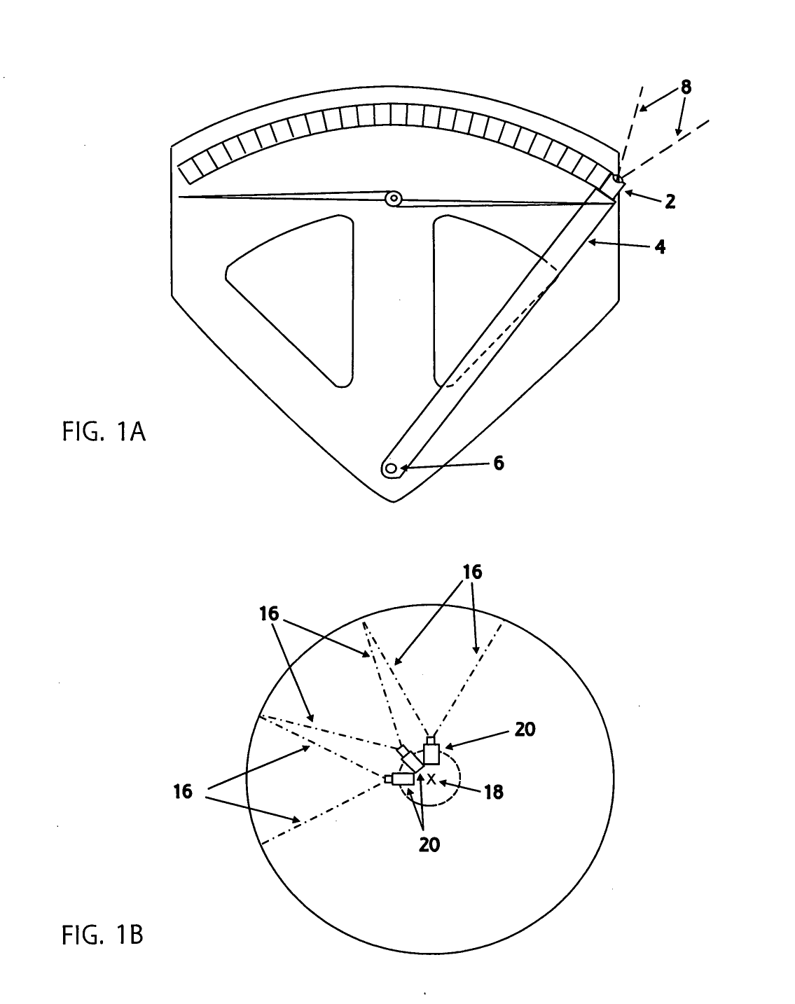

FIG. 1F illustrates Pierce's omnidirectional image capture device.

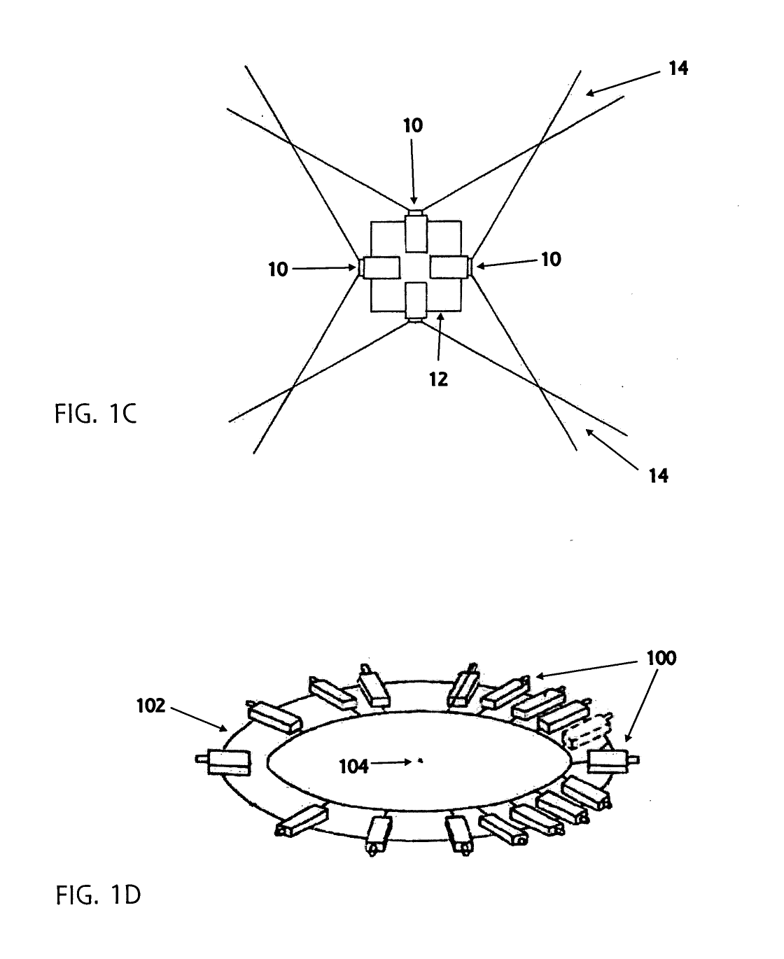

FIG. 2 shows Barman's metal plate for locking in relative positions of imaging components.

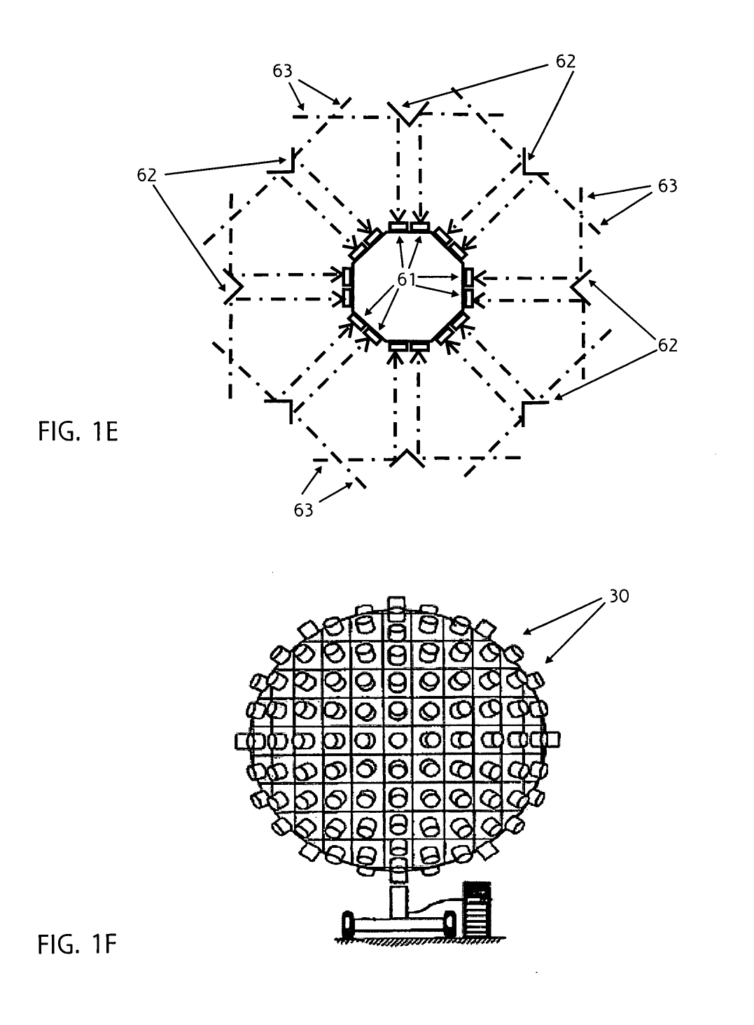

FIGS. 3A through 3C illustrate plan views of 4-, 5-, and 6-sided polygon structures and their respective stereo fields-of-view for a sample wide angle lens according to the present invention.

FIGS. 4A and 4B are frontal and perspective views of imager pair board assemblies 400 that form the side structures of the polygonal imaging system of one embodiment.

FIG. 5A is a plan view (top-down) of a sample pentagonal imaging system according to one embodiment of the present invention.

FIG. 5B is a perspective view of a sample pentagonal imaging system according to one embodiment of the present invention.

FIG. 6 is a perspective view of a sample pentagonal imaging system according to a second embodiment of the present invention.

FIG. 7 is a process flowchart for the dynamic pixel adjustment process for normal and stuck pixels.

### DETAILED DESCRIPTION OF THE INVENTION

The present invention describes an improved and practical stereoscopic imaging system designed to fully capture panoramic or panospheric image pairs. These are collected as either still or video images generated by a plurality of coplanar imager pairs rigidly mounted around a central point. Hence, there are no moving parts in this imaging system. This simplified system produces overlapping stereo image pairs to cover a full 360° field of view without having to produce a mosaic. The system accepts a wide variety of lens arrangements and types, correcting for differences between observed and captured images. Such differences are due to the normal effects of wide angle imaging, as well as lens flaws.

The coplanar arrangement within imager pairs is essential for stereo viewing to reduce post-acquisition correction. An example of such a correction is the adjustment for mutual image sizes caused by having imaging subsystems at different distances from an object field. Furthermore, the planar arrangement of optical centers of imager pairs is important since vertical displacements of imaging components fail to mimic the human visual system. Imagers in each pair are locked into place at normal interocular separation distances, avoiding hypostereo and hyperstereo visual effects. These effects are characterized by foreground objects appearing enlarged or reduced in relation to background scenery depending on how far apart the imagers are (i.e. how much different than normal interocular separation distances).

The mechanical structure of the present imaging system addresses a common problem of every stereo imaging system. This critical problem is that of keeping the imaging subsystems aligned with each other. One embodiment builds a firm fixed framework using the optical elements themselves for a balance between duration of retained calibration time and ease of manufacturing. Another embodiment defines a rigid polygonal frame into which the optical elements are fixedly mounted. All embodiments establish a structure and method that maintains long-lasting mechanical integrity in positioning of optical elements. They further minimize the need for frequent recalibration of the portable imaging system and support repeatable visual measurement capabilities.

Images acquired from the various paired imagers are handled through a dynamic pixel adjustment process. This process corrects for visual deficiencies as the images are being transferred from each imaging subsystem, preferably before storage or transmission. In previous products and designs, most image transformation methods are carried out with post-processing steps usually done on a separate computing platform. This adds to the overall handling time and limits the opportunity for production of real-time video imagery. The present imaging system provides a simplified and streamlined process that is replicated for and runs in parallel on each of the multiple imaging subsystems. The process generates calibrated and corrected images continuously and outputs image data in a readily usable rectilinear form without the necessity of a separate batch-oriented post-processing stage. The process adjusts for imager aspect ratio, distortion due to lens type or power, lens imperfections, imager inaccuracies (stuck or off-color pixels), and other distorting abnormalities on a pixel-by-pixel basis as pixels are being transferred from the imaging chip into on-board working memory. Known values predetermined through calibration processes for each imaging subsystem support the adjustment process. The correction methods of the present imaging system also incorporate into the change mechanism adjustments as needed for image quality (i.e. color; brightness; contrast) balancing and adjustment between imagers in each pair. These methods use pre-calculated or pre-calibrated values for known image conditions, making the imaging system's output more immediately usable.

The present invention defines a stereoscopic imaging system for acquiring panoramic or panospheric images with no moving parts. As such, the system can use ordinary lenses or alternative field of view types of lenses. Examples of useful lens types include wide angle, narrow angle, fisheye, and zoom lenses. The choice of lens type depends on the uses planned for a given model of imaging system. To achieve more expansive stereo views, wide angle lenses would ordinarily be employed as an effective implementation. In accommodating any of a variety of lens types, the collection of imager pair boards of one embodiment forms the sides of any number of regular polygon shapes, such as a square, pentagon, hexagon or other multi-sided polygon. Similarly, these polygonal shapes may serve as the side structures of a single-piece solid framework for supporting the single imager boards and lenses according to another embodiment. For the purposes of illustrating the concept of the imaging system, a pentagonal shape will be used throughout, but it is understood that many other polygon forms would be effective.

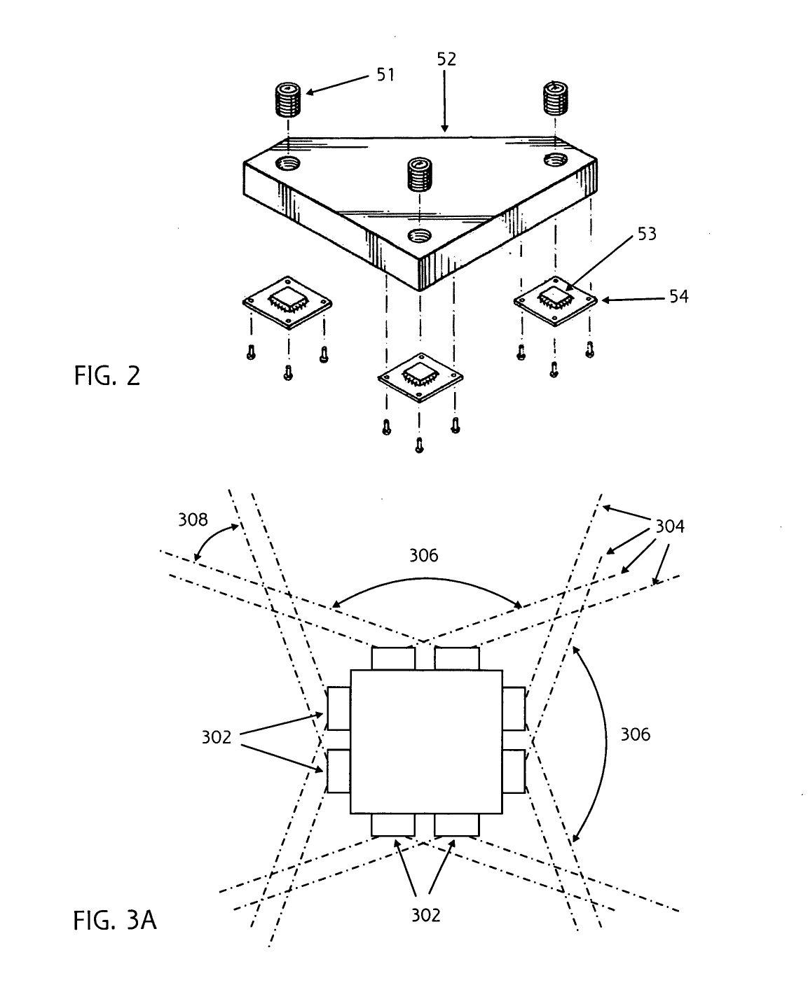

FIGS. 3A through 3C illustrate diagrammatic views of 4-, 5-, and 6-sided polygon structures and their respective stereoscopic fields-of-view for a sample wide angle lens as defined for the present imaging system. In FIG. 3A, dotted lines 304 represent individual extents of viewing range for each optical subsystem 302, while arcs 306 are representative stereo coverage areas for the lenses of a pair of subsystems. Arc 308 denotes areas of stereo coverage subtended by two different sets of adjoining imager pairs. Note that the stereo coverage areas overlap for these lenses, providing a complete panoramic stereoscopic view at locations relatively close to the center of the imaging system. This compares favorably with Shimizu's stereoscopic capability as a function of the distance from the center of the camera. For the purpose of simplified discussion, a 5-sided pentagonal structure will be used throughout the remainder of this disclosure to describe the features of the invention.

Similarly in FIGS. 3B and 3C, dotted lines 304 represent individual extents of viewing range for each optical subsystem 302, while arcs 306 are representative stereo coverage areas for the lenses of a pair of subsystems. Arc 308 denotes areas of stereo coverage subtended by two different sets of adjoining imager pairs. Again, by using wide angle lenses, the foreground stereo coverage is superior to other stereoscopic camera prior art designs.

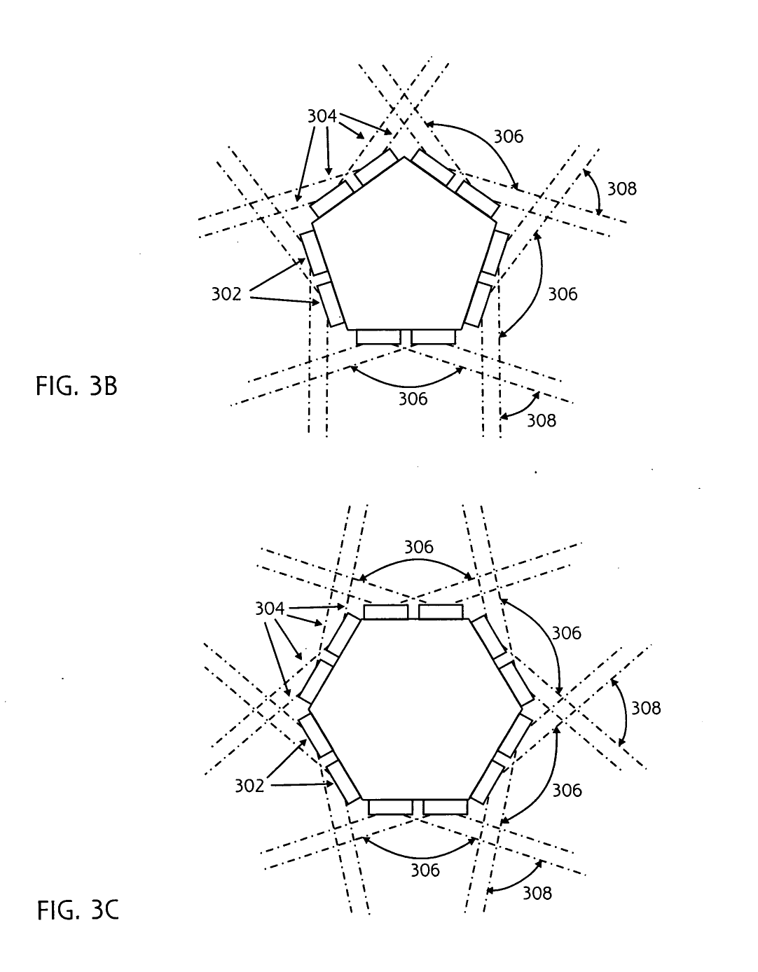

The fundamental structural module of one embodiment is the imager pair circuit board assembly with its assorted components. FIGS. 4A and 4B are frontal and perspective views of a sample imager pair board assembly 400 that forms one of the side structures of the polygonal imaging system according to one embodiment of this imaging system. The key structural elements of FIG. 4A are the imager pair circuit board 402, lens holders 404, vertical support members 408, and the connector plug 410. The connector plug 410 is shown as being made of many pins, but other electrical connection methods are also acceptable. Selected lenses 406 screw into lens holders 404. Imagers (not visible under holders 404) are soldered to boards 402, and lens holders 404 are screwed to imager pair circuit boards 402. Boards 402 are in turn fixedly attached to vertical support members 408, making a solid and rigid structure. FIG. 4B is a perspective view of this same imager pair board assembly 400 with imager pair circuit board 402, lens holders 404, lenses 406, vertical support members 408, and the connector plug 410. It should be apparent that variations in components and sizes of various elements are consistent with the principles of the present invention without explicit delineation.

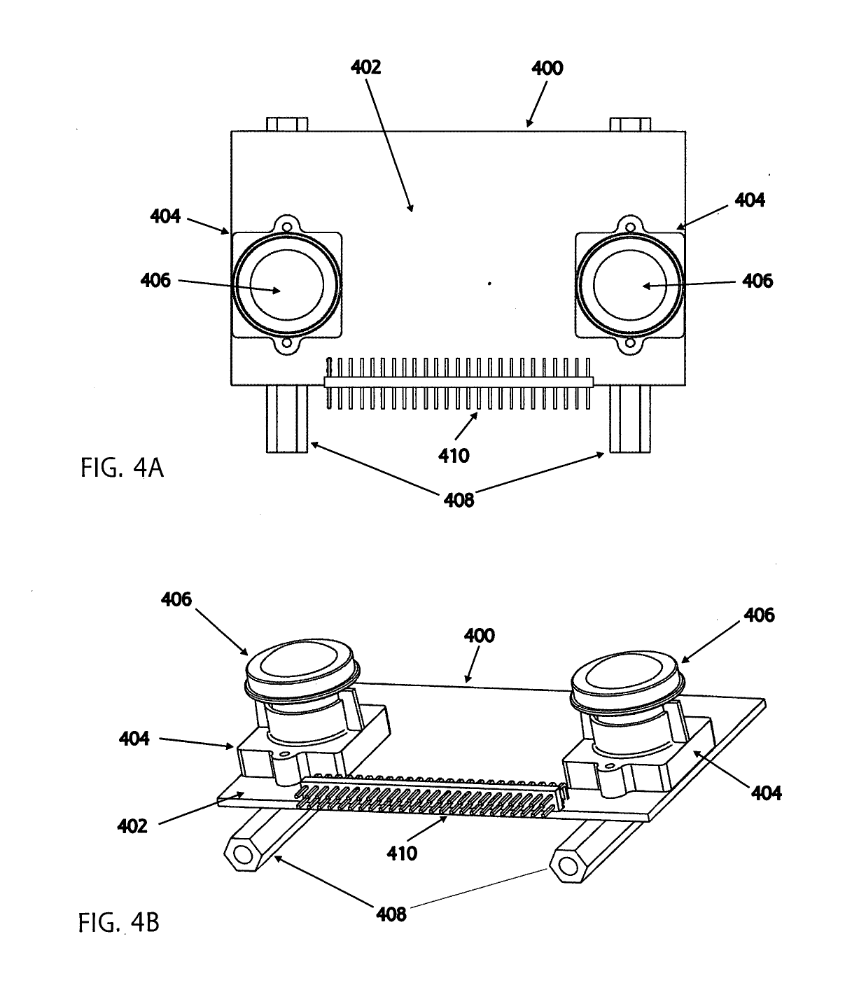

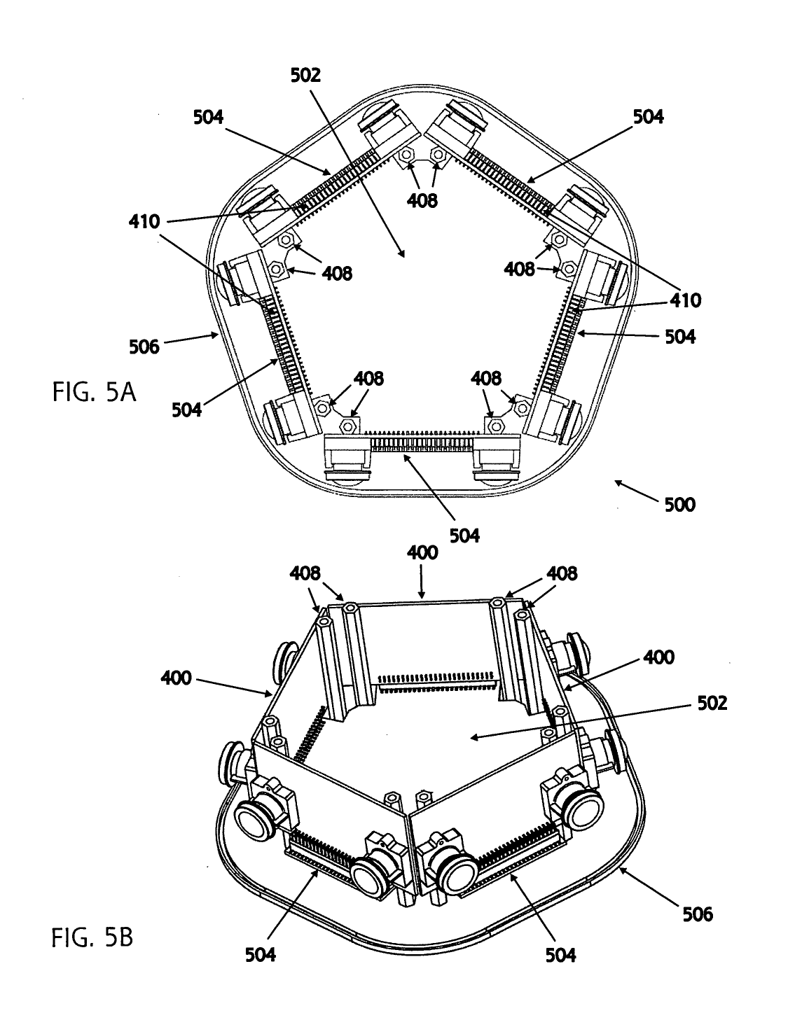

The various board assemblies are integral to the mechanical strength of the packaging innovation in this embodiment. FIG. 5A is a plan view (top-down) of a sample pentagonal imaging system 500. Vertical support members 408 rigidly attach to a base plate 506 and a top plate 508, not shown in FIG. 5A. In conjunction with the imager pair circuit boards, these support members construct a solid frame of which the optical components are integral. This ensures that the various parts remain in place with respect to each other for a long period of time. Note that the rigid rectangular shapes of the circuit board assemblies prevent flexing of the frame. The imager pair board assemblies 400 are further held in place and provide electronic connectivity through the connector plug 410 pins. The plurality of plug 410 pins in one or more rows plug into sockets 504 on a base circuit board assembly 502 mounted to a base plate 506. A perspective view of this embodiment is shown in FIG. 5B.

As all multi-part devices do, the present imaging system has points of positioning variability due to the nature of the manufacturing process and its inherent inaccuracies. Compared to Barman in U.S. Pat. No. 6,392,688, the present imaging system similarly has solder points for the attachment of electronic imagers to their respective circuit boards. It also has potential deviations related to the accuracy of diameter of the holes (and play thereof) attaching the lens holders 404 to the imager circuit boards. There are also variables in the positions of the drilled holes in the imager pair circuit boards 402. In addition, the present imaging system has variable initial positions for the connector plug 410 pins where they are soldered into the imager pair circuit board 402. Although minor, flexible positions also occur where the pins plug into the corresponding connector 504 on the base circuit board 506. Further still, there will be miniscule variations in positions and diameters of holes drilled in the base circuit board 502 and top plate 508.

It is important to note that all of these variable positions are on the order of ten-thousandths of an inch, due to the precision of current manufacturing machinery. However, initial positional variations are mitigated over the long term by other elements of the design and the manufacturing process. Specifically, electronic imaging chips and the connector plugs 410 are soldered down to the imaging pair circuit board 402. Also, screws 510 are screwed through the top plate 508 and base plate 506 into the vertical support members 408 with thread-locking liquids or similar non-movement methods. These processes and structural elements form a rigid framework with only small potential deviation from an ideal configuration. Their successful effect is to hold the components in place in relation to each other for the long term. However, the key function in the manufacturing process is calibration of the elements. Calibration identifies positional dimensions for parts fixed in their locations during the component construction process. Figures of merit derived at calibration are then used later in preparing and presenting corrected images from each of the imaging subsystems. The objective of knowing absolute positions of various components and holding them over long periods of time is achieved in this design.

There are several advantages over prior art patents inherent in the imaging system structural design using imager pair boards. Foremost is its ease of assembly, since individual image pair board assemblies are plugged into a base circuit board and then fixed to upper and lower plates. With 5 such board assemblies for a pentagonal camera device, assembly simplifies to plugging the assemblies, then attaching the top and bottom plates with screws. A second advantage is the lower cost of components that is achieved by replicating the same image pair board assembly multiple times within the final product. Finally, the ability to easily remove and replace imager pair board assemblies dramatically improves serviceability of the overall system. Repair is improved since a failing component can be changed easily without scrapping the entire product.

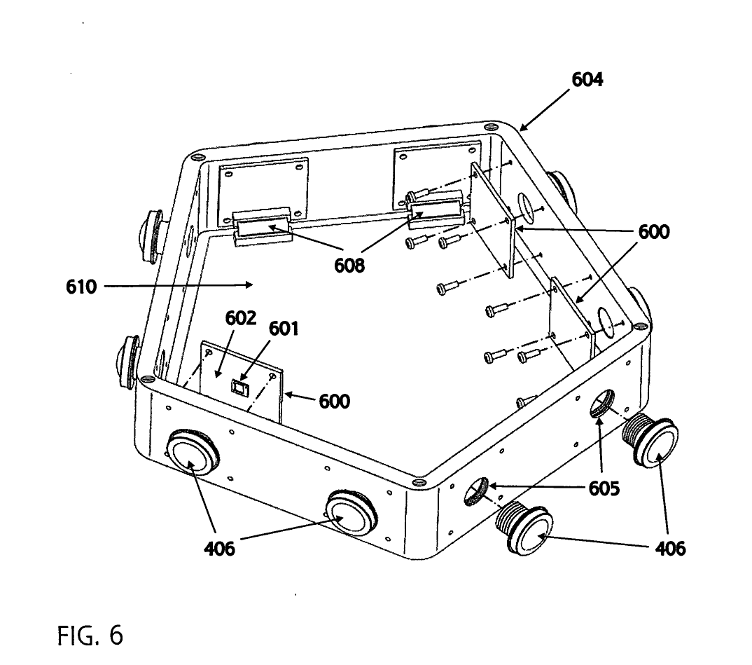

Another embodiment of the imaging system provides a version of this design that stays in calibration even longer than the embodiment using board assemblies. This is achieved through the use of a single solid frame onto which the imaging components are attached. Referring to the perspective view FIG. 6, imager pair board assemblies are replaced by individual imager board assemblies 600. Assemblies 600 are independently screwed into frame 604 at locations precisely positioned by screw holes drilled and tapped into the frame 604. Imaging chips 601 and their associated circuits and components (not shown) are mounted to individual imager circuit boards 602 to form individual image board assemblies 600. Assemblies 600 are electrically connected to the base circuit board assembly 610 through cable assemblies 608 or similar methods. In place of separate lens holders 404, threaded holes 605 are similarly drilled and tapped into frame 604 for supporting lenses 406. The variability in relative positions of all of the imagers and their individual lenses is dramatically reduced. The reduction is to that which would be found in only a single manufacturing machine rather the accumulation of errors from many separate machines and processes. Maintaining high accuracy in a single mechanical device enhances the precise relative positioning of all collective components in relation to each other. This is obviously a desirable feature for a camera with multiple optical subsystems. Note that the height and thickness of frame 604 may differ from one implementation of the design to another based on lens and imager types selected. Also note that a metallic material with limited thermal expansion and flexibility such as aluminum is preferred.

The strengths of this embodiment are its resistance to de-calibration over time and its low cost to repair. In the first point, once calibrated, components cannot shift in position relative to each other due to the solid nature of frame 604. In this embodiment, all optical components are fixed in place. While shock and vibration might jar the base circuit board assembly 610, the critical components are held firmly. In the second point, the use of multiple identical individual imager board assemblies 600 reduces the cost of individual copies of this component through higher volume manufacturing. Each such assembly is replaced easily by removing the screws that hold the top plate 508 (not shown) and unscrewing the assembly from the frame 604.

This embodiment is distinct from Barman in U.S. Pat. No. 6,392,688 in at least one major way. Barman's use of a flat plate limits his device to stereoscopic views in a single direction. The present imaging system is designed for panoramic stereoscopy, capturing stereoscopic views in all directions around a plane at one time. Imaging subsystems in the present design are preferably placed at normal interocular separation distances. However, they can alternately be placed at greater or lesser separation distances to intentionally facilitate hyperstereo or hypostereo viewing effects.

A practical implementation of this imaging system supports indoor use. For that, lighting is often required. To that end, both embodiments of this system provide for the attachment of a lighting element that is plugged onto the top cap of the camera. This lighting device provides uniform lighting in all directions from a central point above the imaging system causing minimal shadows below. The device is designed to operate as needed when stereo photos or video is being captured.

### DETAILED OPERATION OF THE INVENTION

To achieve effective stereoscopy, the present imaging system is calibrated after all components are assembled. This accommodates the variations derived from the various manufacturing process stages, as well as shortcomings of the components themselves as described earlier. A first kind of calibration involves determination of mechanical variants found in the physical placement of the lenses and imaging chips in relation to each other. It also identifies the flaws in the lenses themselves. This type of calibration is routinely accomplished in the industry by temporarily fixing the position of the camera to be calibrated in front of a field of objects or light sources. Once placed, the actual location of each ray of light is determined and compared against the ideal location of each ray for a given lens type.

Having thus been determined, differences in actual values from the ideal are then recorded in the portable imaging system unit. The differences are then used to adjust the position of recorded pixels prior to storing the collective image in on-camera memory or transmission. This calibration data is preferably stored in the imaging system electronics in non-volatile memory. The technique also handles aspect ratio correction and other transforms to correct image distortions due to wide angle and other types of lenses. The end result preferred is a rectilinear image produced within the imaging system, simplifying the demands of post-processing.

A second type of calibration is done with respect to colors and brightness. Despite automated manufacturing processes that have high repeatability and precision, imaging chips still have variations in their color filters that cause differences from chip to chip. Similarly, there are also different responses to light intensity on each chip. When used individually in digital cameras, there is no immediate reference against which to compare. However, in stereoscopic cameras where there is a plurality of imaging chips, the human eye readily detects the variations in outputs of each chip. This therefore reduces the effectiveness of the stereoscopic effect. To that end, calibration for color and light intensity variations is important for the present design.

Color and light intensity calibration are routinely accomplished by techniques similar to those used for mechanical calibration. An all-encompassing field of light sources is varied through a sequence of known frequencies (colors) and intensities and presented to the image sensors of the stereoscopic camera being calibrated. The data acquired on a point-by-point basis is compared against the ideal frequency and brightness data. The differences for each pixel are recorded in memory within the imaging system and used to adjust the acquired image prior to storing within or transmission from the imaging system. The calibration data so recorded is used to correct the pixel data for a variety of conditions. These include pixel position, lens type, brightness, color and flaws. The brightness comparison is with reference to the other member of an imager pair or other pairs. The color comparison is made to the other member of an imager pair or other pairs. Finally, flaws are identified in individual optical components. All of this occurs prior to image storage within the imaging system. The resultant image is optionally compressed or transmitted in an uncompressed rectilinear form for displaying or post-processing on separate display or computing platforms.

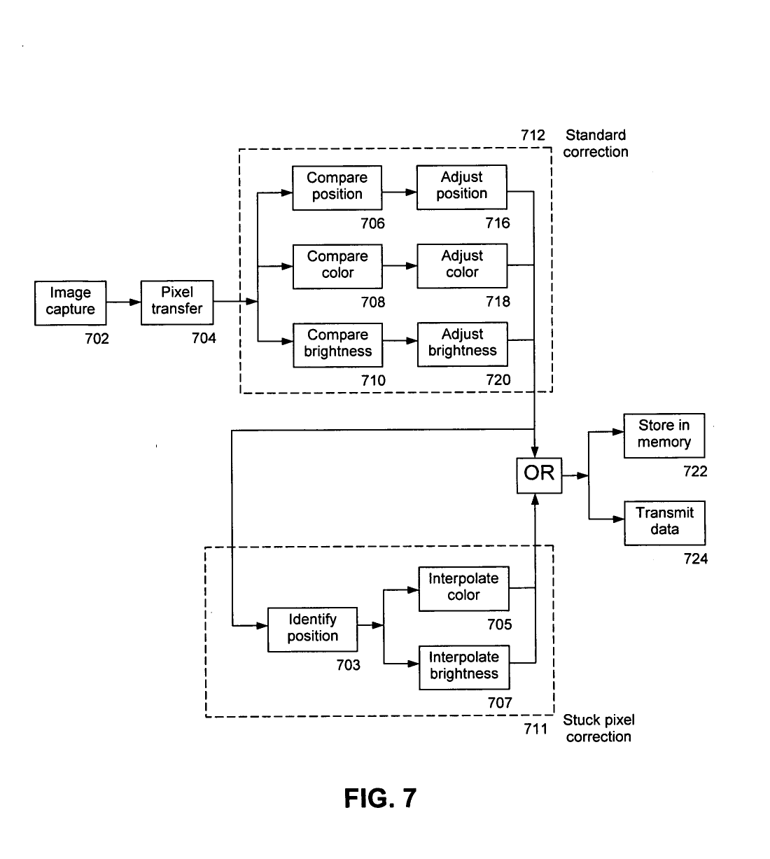

Dynamic pixel adjustment is performed for each imaging subsystem as pixels are transferred from the imaging chips to the main circuits of the imaging system, as diagrammed in FIG. 7. This is done preferably in solid-state circuitry for each imaging subsystem on the camera. Alternatively, it is accomplished as a separate processing step using working memory in the camera and some processing devices. For the light output of each position of an imaging chip, a known set of changes is made each time image data is transferred from the camera. The set of changes is predetermined by knowledge of specific camera and lens characteristics discovered through prior calibration measurements and analysis. Pixel information is modified according to whether pixel attributes require change for a given pixel. This decision includes whether the pixel is stuck on or off. The desired result of such changes is to produce rectilinear images that compensate for lens and imager variations. Variations include lens distortion and flaws, non-standard colors, and different brightness values between imaging devices in an imaging pair. If an imaging chip generates an output pixel normally (i.e. not due to pixels stuck on or off), it will follow process 712 for other corrections of the pixel attributes. If a pixel is not producing information (stuck off) or consistently producing incorrect information (stuck on), pixel data will be generated according to process 711 for stuck pixel attributes.

It is useful to examine the dynamic pixel adjustment for the case of an individual pixel, since it will be replicated millions of times for each captured image. Overall, handling of imaging data for a given pixel begins with the capture process 702 at each imager. This is followed in either video or still modes by transferring pixels from the imager to the processing device in step 704. For the cases in which this imager's pixel position has not been previously identified as stuck on or off, pixels are transferred from the imager through the standard correction process 712. In process 712, the attributes of position, color and brightness are compared against calibration reference data in comparison processes 706, 708 and 710, respectively. Reference data has been determined in an afore-mentioned previous calibration process. Based on the pixel attribute comparison values, each attribute is adjusted in the processing device for the set of its values. These values are adjusted with respect to position in process 716, color in process 718, and brightness in process 720. The corrected pixel attribute information is then available for either internal storage 722 or transmission out of the camera 724. This information is also provided to the stuck pixel process 711 to provide the necessary data for handling these anomalies.

In the circumstance in which a given pixel position for a given imaging chip has been previously identified as defective, non-defective adjoining pixel information is transferred from the imager into process 711. The attributes of color and brightness are interpolated from the normal pixel attribute data as has been developed in process 712. The stuck pixel is identified from recorded reference data in step 703. Once selected, values are interpolated for color and brightness in processes 705 and 707. Interpolated values of these attributes are generated from the defective pixel's adjoining pixels following principles ordinarily known and used in the present art. One such principle derives an average value from the pixels surrounding the stuck-on or stuck-off pixel. The interpolated pixel attribute information is then available for either internal storage 722 or transmission out of the camera 724.

We claim:

1. An imaging system, comprising:
a plurality of image capture devices for translating electromagnetic radiation to electrical energy representing pixel data;
a plurality of lenses for focusing said radiation on said image capture devices; and
a framework for positioning said image capture devices and said lenses as coplanar optical subsystem imager pairs held firmly in place in relation to each other and directed as pairs outwardly from a central point to cover at least 360° of view;
whereby said imaging system produces stereoscopic image data sets covering a panoramic or panospheric field of view.

2. The imaging system of claim 1, wherein said lenses are consistently similar in a given implementation and selected from a group consisting of wide angle, narrow angle, fisheye lenses, zoom or other lenses as are ordinarily used to refract light onto image capture devices.

3. The imaging system of claim 2, wherein the components of each pair of said optical subsystems formed from the combination of two said capture devices and said associated lenses are spaced at normal human interocular separation distances of about 65 mm, thereby minimizing hyperstereo and hypostereo visual effects upon reproduction.

4. The imaging system of claim 1, wherein said framework for positioning said capture devices and said lenses forms a regular polygon and is comprised of:
imager pair board assemblies to which are mounted said capture devices and said lenses;
vertical support members firmly affixed to said assemblies; and
base and top plates, into which said support members are attached;
whereby a rigid framework is established that maintains the relative positions of optical system components for long periods of time, thereby reducing recalibration requirements.

5. The imaging system of claim 1, wherein said framework for positioning said image capture devices and said lenses forms a regular polygon and is comprised of:
a single solid frame onto which said capture devices and their respective circuit boards are attached, and
into which said lenses are attached, said framework of which is further joined to base and top plates with screws or other attachment means,
whereby a rigid framework is established that maintains the relative positions of optical system components for long periods of time, thereby reducing recalibration requirements.

6. An imaging system, comprising:
a plurality of image capture devices for translating electromagnetic radiation to electrical energy representing pixel data;
a plurality of lenses for focusing said radiation on said image capture devices;
a framework for positioning said image capture devices and said lenses as coplanar optical subsystem imager pairs held firmly in place in relation to each other and directed as pairs outwardly from a central point to cover at least 360° of view; and
processing means for combining said acquired pixel data with image calibration data that has been previously captured to change characteristics of said acquired pixel data, a method called dynamic pixel adjustment;
whereby said imaging system produces corrected stereoscopic image data sets covering a panoramic or panospheric field of view.

7. The imaging system of claim 6, wherein said lenses are consistently similar in a given implementation and selected from a group consisting of wide angle, narrow angle, fisheye lenses, zoom or other lenses as are ordinarily used to refract light onto image capture devices.

8. The imaging system of claim 7, wherein each pair of optical subsystems formed from the combination of two image capture devices and their associated lenses are spaced at normal human interocular separation distances of about 65 mm, thereby minimizing hyperstereo and hypostereo visual effects upon reproduction.

9. The imaging system of claim 6, wherein said framework for positioning said capture devices and said lenses forms a regular polygon and is comprised of:
imager pair board assemblies to which are mounted said capture devices and said lenses;
vertical support members firmly affixed to said assemblies; and
base and top plates, into which said support members are attached;
whereby a rigid framework is established that maintains the relative positions of optical system components for long periods of time, thereby reducing recalibration requirements.

10. The imaging system of claim 6, wherein said framework for positioning said image capture devices and said lenses forms a regular polygon and is comprised of:
a single solid frame onto which said capture devices and their respective circuit boards are attached, and
into which said lenses are attached, said framework of which is further joined to base and top plates with screws or other attachment means,
whereby a rigid framework is established that maintains the relative positions of optical system components for long periods of time, thereby reducing recalibration requirements.

11. The imaging system of claim 6, wherein the method of dynamic pixel adjustment for correcting acquired position, color, and brightness characteristic values of each pixel, comprises:
providing hardware or software means in which said characteristic values are temporarily stored for comparison with calibration values that have been previously determined; and
providing hardware or software means in which said characteristic values are compared with said calibration values to correct said characteristic values for more preferred values; and
for pixels that are not stuck on or off in the image capture device, performing comparisons and correction of pixel position due to lens distortion or flaws, comparison and correction of color for each pixel, and comparison and correction of brightness for each pixel; and
for pixels that are either stuck on or off in the image capture device, determining new values for color and brightness through interpolation of values from adjacent surrounding pixels; and
providing hardware or software means in which said characteristic values for comparable pixel positions between said elements of an imaging pair are balanced for more common brightness values;
whereby said correction steps handle imaging system shortcomings such as lens distortion and flaws, differences from ideal values of color and brightness for pixels of image capture devices, and differences between relative brightness values of individual image capture devices.
